(19) United States
(12) Patent Application Publication
(10) Pub. No.: US 2009/0117012 A1
(43) Pub. Date: May 7, 2009

(54) Air Treatment Device Utilizing A Sensor For Activation And Operation

(75) Inventors: Jeffrey Bankers, Phoenix, AZ (US); Sanam Nassirpour, Phoenix, AZ (US); Kevin Hafer, Chandler, AZ (US)

Correspondence Address: SNELL & WILMER, LLP (Dial Corp), ONE ARIZONA CENTER, 400 E. VAN BUREN, PHOENIZ, AZ, 85004-2202, US

(73) Assignee: THE DIAL CORPORATION, Scottsdale, AZ (US)

(21) Appl. No.: 12/265,916

(22) Filed: Nov. 6, 2008

Related U.S. Application Data
(60) Provisional application No. 60/986,164, filed on Nov. 7, 2007.
(60) Provisional application No. 60/986,172, filed on Nov. 7, 2007.

(51) Int. Cl. B01J 19/00

(52) U.S. Cl. 422/105; 422/123

(57) ABSTRACT

The present invention provides a system for detecting a malodor and dispensing an air treatment when needed. In an exemplary embodiment of the present invention, the system includes a selection mechanism which allows the user to choose how the system dispenses the air treatment, a sensor, a timing control circuit coupled with the sensor, and a delivery system coupled with the timing control circuit. Upon detection of a malodor by the sensor, the sensor communicates with the timing control circuit which, in turn, communicates with the delivery system to dispense the air treatment. In another exemplary embodiment of the present invention, an air-freshening system is shown that combines a continuous dispensing system with a sensing dispensing system.

### CROSS-REFERENCE TO RELATED APPLICATIONS

This Non-Provisional patent application claims the benefit of U.S. Provisional Patent Application Ser. No. 60/986,164, entitled AIR TREATMENT DEVICE UTILIZING A SENSOR FOR ACTIVATION AND OPERATION and filed Nov. 7, 2007 and U.S. Provisional Patent Application Ser. No. 60/986,172, entitled AIR TREATMENT DEVICE WITH A SENSOR and filed Nov. 7, 2007, both of which are incorporated by reference herein in their entireties.

### FIELD OF INVENTION

The present invention generally relates to vapor-dispensing devices. More particularly, the system may include burst vapor-dispensing, based in part upon a timing control circuit configured to operate in different modes, for example, a detection mode, a timed mode and/or an on-demand mode. The system may also include a continuous dispensing system.

### BACKGROUND OF THE INVENTION

Vapor-dispensing products typically include a volatizable material and a transport system configured to facilitate evaporation of the volatizable material into the surrounding air. For example, in some systems, a liquid material is contained in a reservoir bottle, and is volatized with heat, pump, aerosol, fan, etc.

Vapor-dispensing products are often described using terms such as “continuous,” “burst,” “passive,” “active” and/or “on-demand.” A continuous delivery system requires no initiation while a burst system provides an instantaneous increase in vapor intensity, for example, in the form of an aerosol or spray release. As used herein, a passive system is one which delivers vapor without the need for additional energy input to the system (e.g., ambient evaporation). In contrast, an active system requires additional energy input, typically in the form of one or more heating elements or fans (e.g., forced evaporation). An on-demand system requires periodic initiation.

Air fresheners are common exemplary vapor-dispensing products and are often classified as continuous fresheners or burst fresheners. Continuous fresheners, passive or active, provide substantially constant air treatment intensity over extended periods of time and typically include a reservoir and a wick or some other air treatment pathway.

Burst fresheners are typically designed to provide instantaneous dispersions, for example, to combat transient or elevated odor levels, and lack the prolonged effect provided by continuous fresheners. Conventional burst fresheners often employ aerosol propellants or mechanical type pumps and spray nozzles to create dispersions that typically dissipate quickly. Air treatment from burst fresheners is typically released on-demand. However, burst fresheners may be configured to operate in different modes, for example, a detection mode, a timed mode and/or an on-demand mode.

Known vapor-dispensing devices of this type may be improved upon in a number of respects. For example, some vapor-dispensing devices dispense fragrance vapor at times when the fragrance may not be needed. Furthermore, some devices do not emit enough fragrance vapors when certain malodors are present. Additionally, certain malodors associated with different locations, i.e., kitchen, bathroom, laundry room, locker, children's closet, etc, may be treated more effectively with certain fragrances.

In short, there is no available product providing a burst release, and optionally a continuous release, where the burst release is on-demand, at a timed interval, or in response to detecting a malodor or a decreased level of air treatment material. Thus, there is a need for a vapor-dispensing device that overcomes these and other limitations of the prior art.

### SUMMARY OF THE INVENTION

The present invention provides a burst system for dispensing an air treatment when needed. In an exemplary embodiment of the present invention, an air treatment system for detecting a malodor or a decreased level of air treatment material and dispensing an air treatment is provided. In accordance with various embodiments, the system includes a housing, a sensor, a timing control circuit coupled with the sensor, and a delivery system coupled with the timing control circuit.

The timing control circuit communicates with the delivery system to dispense the air treatment. The system may also include a selection mechanism which allows the user to choose how a burst system dispenses the air treatment. For example, in exemplary embodiments, the burst system dispenses the air treatment on-demand or at a timed interval.

In another exemplary embodiment of the present invention, an air-freshening system is shown that combines a continuous dispensing system with a burst dispensing system. The continuous dispensing system provides a continuous fragrance. In exemplary embodiments, the continuous dispensing system and the burst dispensing system can have common or different (e.g., complimentary) fragrances in common or separate reservoirs.

In an exemplary embodiment, the sensor comprises a tuning fork having a distinctive resonant frequency and at least two prongs, and a wire coupled between the prongs, wherein malodors interact with the wire, change a property of the wire, and thereby change the resonant frequency of the tuning fork. Changing the resonant frequency of the tuning fork thus results in an electrical charge and an indication signal being sent to the timing control circuit.

### BRIEF DESCRIPTION OF THE DRAWINGS

These and other features, aspects and advantages of the present invention will become better understood with reference to the following description, appending claims, and accompanying drawings where:

FIG. 1 shows a view of an air treatment device;

FIG. 2 shows an alternate embodiment of a view of an air treatment device;

FIG. 3 shows a block diagram of a method and system of an exemplary air treatment device;

FIG. 4 shows a tuning fork sensor in accordance with an exemplary embodiment;

FIG. 5 shows a flow diagram of a method and system of active dispensing, according to an exemplary embodiment; and

FIG. 6 shows a flow diagram of a method and system of active dispensing, according to an exemplary embodiment.

### DETAILED DESCRIPTION

The following descriptions are of exemplary embodiments of the invention only, and are not intended to limit the scope or applicability of the invention in any way. Rather, the following description is intended to provide convenient illustrations for implementing various embodiments of the invention. As will become apparent, various changes may be made without departing from the spirit or scope of the invention as set forth in the appended claims.

For the sake of brevity, functional embodiments of the apparatus and systems (and components of the individual operating components of the systems) may not be described in detail herein. Furthermore, the connecting lines shown in the various figures contained herein are intended to represent exemplary functional relationships or physical connections between the various elements. It should be noted that many alternative or additional functional relationships or physical connections may be present in a practical system.

As used herein, air treatment material may comprise one or more of fragrances, air fresheners, deodorizers, odor eliminators, odor counteractants, insecticides, insect repellants, medicinal substances, disinfectants, sanitizers, mood enhancers, and aroma therapy compositions, scented water, oil, alcohol, gel, solids or membrane type air treatment material.

In accordance with various embodiments of the present invention, an air treatment device is configured to detect a malodor with a sensor and actively respond to the malodor by dispensing an air treatment or fragrance into the surrounding environment. In an exemplary embodiment, the device is further configured to detect the air treatment or fragrance and regulate later dispensing accordingly.

In an exemplary embodiment, in addition to a burst delivery mechanism, the present invention includes a continuous delivery mechanism for providing an air treatment material. The continuous delivery mechanism may be passive or active. As used herein, continuous can mean constant or at regular timed intervals. The burst delivery mechanism may be configured to operate in different modes, for example, a detection mode, a timed mode, an on-demand mode, or any combination of the same. Additionally, in accordance with various aspects of exemplary embodiments, the continuous and burst delivery mechanisms can have common or different (e.g., complimentary) fragrances in common or separate reservoirs.

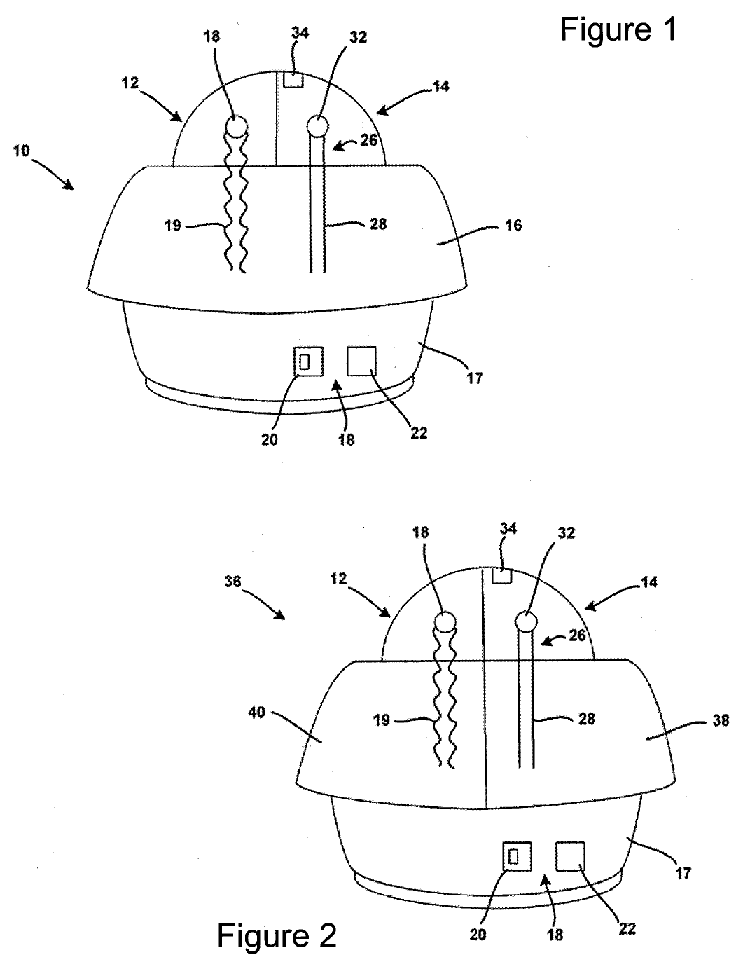

Referring now to FIGS. 1 and 2, an exemplary air treatment device 10 in accordance with one aspect of the present invention is shown. The air treatment device 10 includes a continuous delivery mechanism 12 and a burst delivery mechanism 14. In one embodiment, shown in FIG. 1, the continuous delivery mechanism 12 and the burst delivery mechanism 14 each draw from a common reservoir 16 which is received in a base 17.

The continuous delivery mechanism 12 comprises an emanator 18 in communication with the common reservoir 16 via a conduit 19 for transporting an air treatment material. It should be understood by one of ordinary skill in the art that any suitable emanator 18 may be used as a continuous delivery mechanism.

As is understood by one of ordinary skill in the art, the continuous delivery mechanism 12 may be an active mechanism including one or more heating elements and optionally, one or more variable temperature controls to controllably alter or maintain the amount of air treatment material dispersed depending on user desired performance, room size and the like. Likewise, the active mechanism may include one or more blowers or fans to help with dispersing the air treatment material throughout the surrounding area.

As shown in FIGS. 1 and 2, the burst delivery mechanism 14 includes a sensor system comprising a selection mechanism 20, a sensor 22, a timing control circuit 34, and a delivery system 26. The delivery system 26 communicates with the reservoir 16 via a conduit 28 to supply the air treatment. Transportation through conduit 28 can be by any means known by one of ordinary skill in the art. Some examples include but are not limited to pumps, aerosol or any other propellant mechanism. The operation of the sensor system depends on the consumer's desired interaction (or lack thereof). For example, a consumer may wish to have the sensor 22 activate the burst delivery mechanism 14 while in other situations activation of the burst delivery mechanism 14 may be unwanted. Additionally, in certain instances a consumer may wish to have timed treatment. A consumer may wish to have both timed treatment and sensor activated treatment. Still further, a consumer may wish to manually activate the burst delivery mechanism 14 for instant air treatment material dispersal.

In an exemplary embodiment, the delivery system 26 comprises spray nozzle 32 that delivers an air treatment material immediately into the air. The delivery system 26 is not meant to be limiting and may comprise an atomizer, spritzer, sprayer, pump, nozzle, or any other suitable dispenser. In other words, it should be understood by one of ordinary skill in the art that any delivery system now known or as yet unknown in the art can suitably be configured to be used in the present invention.

With reference to FIG. 2, an additional embodiment of an air treatment device 36 is shown having a pair of reservoirs 38, 40. The air treatment device 36 is similar to the air treatment device 10 with the exception of the pair of reservoirs 38, 40. The reservoirs 38, 40 may contain identical, different, or complimentary air treatment materials. The reservoirs 38, 40 may be single use, refillable, or removable containers. Accordingly, customers may choose between single air treatment material release, overlapping complimentary air treatment material releases, and may change combinations by selection of alternate air treatment material refills. For example, a first air treatment material may be continuously dispersed into the environment with a second air treatment material for burst dispersion. Alternatively, the first and second air treatment material refills may be interchangeable to provide the inverse relationship. Conversely, continuous delivery mechanism 12 and burst delivery mechanism 14 may be interchangeably insertable into reservoirs 38, 40. It is understood that any number of components may readily be rearranged or substituted without departing from the present invention.

In accordance with various embodiments of the present invention, activation or operation of an air treatment device with a sensor depends on the consumer's desired interaction (or lack thereof). Specifically, in certain instances a consumer may wish to have timed treatment, i.e., the air treatment device is active at certain times or for certain periods. Additionally or alternatively, in certain situations a consumer may wish to have a sensor activated or deactivated air treatment device, for example, for conservation of power. Still further, a consumer may wish to have both timed treatment and sensor activated treatment.

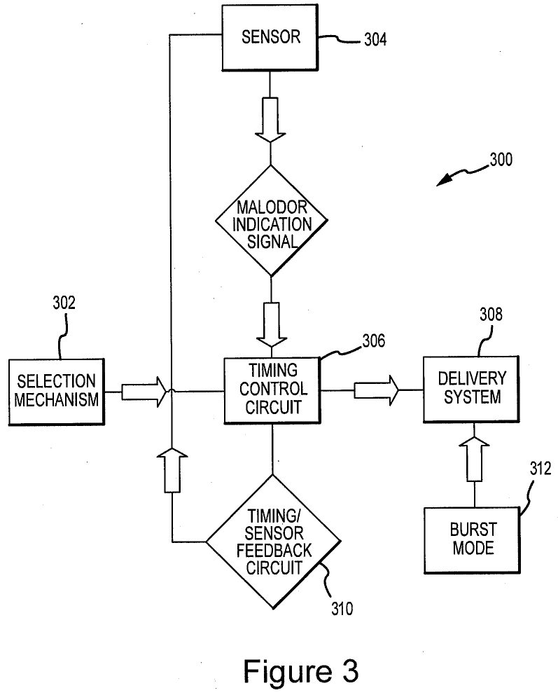

It should be understood that while various exemplar) embodiments described above comprises a continuous dispensing system and a burst dispensing system, other exemplary embodiments only comprise a burst dispensing system. In an exemplary embodiment, for example, the one shown in FIG. 3, an air treatment system 300 includes a housing, a selection mechanism 302, a sensor 304, a timing control circuit 306, and a delivery system 308.

The selection mechanism 302 operates to indicate in what mode the air treatment system will operate. In accordance with various embodiments, the selection mechanism 302 is set for a timed treatment, a sensor activated treatment, or a combination thereof. In such embodiments, each of the timed and sensor activated treatment may be adjusted to high, medium, low, or off, depending on the consumer's desired level of treatment. The selection mechanism 302 communicates with the timing control circuit 306 to help assure the consumer's desired level of treatment. In accordance with one aspect of various embodiments, the selection mechanism 302 is a switch or any other suitable mechanism that allows the consumer to indicate in what mode the air treatment system will operate.

In exemplary embodiments, the sensor 304 samples the environment for either the level of active air treatment material or the quality of the current environment. In exemplary embodiments, the sensor 304 is capable of distinguishing between a plurality of malodors in a plurality of locations such that a single air treatment system may be used in multiple locations. In exemplary embodiments, the sensor 304 is capable of detecting motion, heat, light, air treatment material intensity, humidity or other ambient conditions as a way of initiating an air freshener's continuous or burst delivery mechanisms. In an exemplary embodiment, the sensor 304 is a metal oxide sensor (MOS), however, it should be understood by one of ordinary skill in the art that any suitable sensor exhibiting the qualities discussed herein may be used in the context of the present invention.

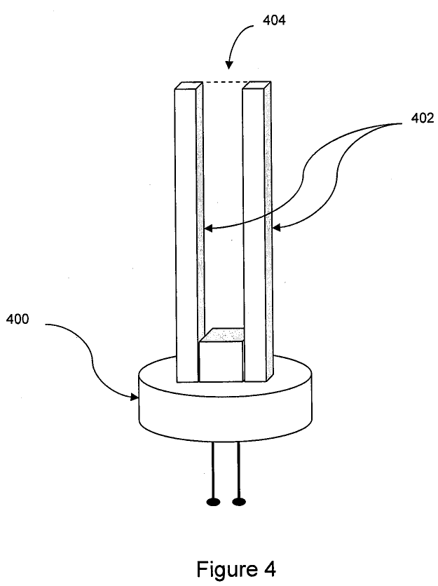

For example, in accordance with an exemplary embodiment, and with momentary reference to FIG. 4, sensor 304 used in accordance with the present invention may comprise a vibrating structure such as that disclosed in the published PCT Application Serial No. PCT/US2005/016221 entitled “Chemical and Biological Sensing Using Tuning Forks,” incorporated herein by reference in its entirety, which may be adapted to detect and/or distinguishing between a plurality of malodors. In various embodiments, one fork or an array of forks, depending on the particular application and/or needs, may be used.

In accordance with one aspect of an exemplary embodiment, a vibrating structure comprises a tuning fork 400 having a distinctive resonant frequency and at least two prongs 402, and a wire 404 (e.g., a polymer wire) coupled between prongs 402, wherein malodors interact with wire 404, change a mechanical property of wire 404, and thereby change the resonant frequency of tuning fork 400.

In accordance with an exemplary embodiment, wire 404 comprises one or more materials, naturally occurring or man-made, having a property which may be changed upon interaction with one or more malodors. In accordance with one aspect of an exemplary embodiment, wire 404 is composed of one or more metallic or porous materials, for example, various polymer materials, including polymer solutions. In accordance with one aspect of an exemplary embodiment, wire 404 is formed by pulling a polymer solution into a polymer strand. A polymer solution may comprise one or more polymers dissolved in one or more solvents or melted by heating. In accordance with an exemplary embodiment, the materials are stable under ambient conditions.

In accordance with an exemplary embodiment, wire 404 materials allow specific adsorption of one or more malodors. For example, if Palladium (Pd) wire is used, the specific adsorption of hydrogen molecules can change the mechanical properties of the Pd wires. In accordance with one aspect of an exemplary embodiment, when a polymer wire is solidified, a large mechanical stress is built in the wire, which can be released upon binding or adsorption of a respective chemical or biological analyte species.

As an example, in an exemplary embodiment, wire 404 comprises ethylcellulose or similar material, and the adsorption of ethanol vapor changes at least one property of wire 404 (e.g., oscillation amplitude), and thereby changes the resonant frequency of tuning fork 400. While not wishing to be bound by theory, it is thought the adsorption of malodors can change both the mass and the spring constant of wire 404. In general, wire 404 may be composed of any material configured to detect and/or distinguishing between one or more malodors.

In accordance with an exemplary embodiment, tuning fork 400 comprises materials with piezoelectric properties, such as piezoelectric crystals which convert mechanical stresses to electrical charge. In accordance with one aspect of an exemplary embodiment, tuning fork 400 is composed of quartz crystal. One skilled in the art will appreciate that any material having piezoelectric properties is suitable for use with the present invention. For example, tuning fork 400 may comprise one or more of each of a crystal, naturally occurring or man-made, a ceramic and a polymer. In accordance with one aspect of an exemplary embodiment, tuning fork 400 has a resonant frequency of about 31 to about 36 KHz, more preferably about 32 to about 34 KHz, and most preferably about 32.8 KHz.

With momentary reference back to the earlier ethanol vapor example, changing the resonant frequency of tuning fork 400, wherein tuning fork 400 is composed of quartz crystal, would result in an electrical charge and an indication signal being sent to timing control circuit 306.

Turning back to FIG. 3, the timing control circuit 306 in turn activates the air treatment system 300 and causes the delivery system 308 to disperse the air treatment. The timing control circuit 306 allows for a timed treatment, a sensor activated treatment or a combination thereof. For the timed treatment, the air treatment system 300 is activated in a timed manner that is controlled in terms of both the duration of the treatment, commonly referred to as “on time” and the intervening time between treatments, commonly referred to as “off time”. In an exemplary embodiment, the timing control circuit 306 contains interval timed programming wherein air treatment material is dispersed in predetermined intervals during the timed treatment.

For the sensor activated treatment, the timing control circuit 306 and the sensor 304 are interconnected by a feedback circuit 310 such that the sensor 304 controls the timing control circuit 306 and vice-versa. Thus, the sensor 304 controls the timing control circuit 306 in that, when the sensor 304 detects a malodor or low level of an air treatment, an indication signal is sent to the timing control circuit 306. The timing control circuit 306 will then cause the delivery system 308 to disperse the air treatment.

In an exemplary embodiment, the timing control circuit 306 disengages the sensor 304 for an operational time period via the feedback circuit 310 if the timing control circuit 306 determines a significant time period of increased air treatment or decreased malodor.

In another exemplary embodiment, the device is further configured to detect the air treatment or fragrance and regulate later dispensing accordingly. In accordance with an aspect of an exemplary embodiment, the timing control circuit 306 disengages the sensor 304 for an operational time period via the feedback circuit 310 if the sensor 304 determines a significantly increased air treatment intensity. In accordance with another aspect of an exemplary embodiment, the timing control circuit 306 engages the sensor 304 for an operational time period via the feedback circuit 310 if the sensor 304 determines a significantly decreased air treatment intensity.

Among other advantages, in some embodiments the interconnection of the timing control circuit 306 and the sensor 304 by the feedback circuit 310 allows for power conservation. For example, in exemplary embodiments the sensor 304 has to be heated to work and power is conserved if the timing control circuit 306 also controls the sensor 304. For example, the timing control circuit 306 can turn off the sensor 304 when it is not needed.

The delivery system 308 expels the air treatment material when the level or presence of a malodor is detected by the sensor 304 or in accordance with a timed treatment. The delivery system 308 receives the signal from the timing control circuit 306. The delivery system 308 can be any system capable of dispensing the air treatment material as appreciated by one of ordinary skill in the art.

Another aspect in accordance with various embodiments of the invention is the burst mode 312. In one embodiment, the burst mode 312 is initiated by an actuator on the device to immediately dispense the air treatment. In one embodiment, the burst mode 312 would communicate with the timing control circuit 306, which would then activate the delivery system 308 to relatively immediately dispense the air treatment. In another embodiment, as shown in FIG. 1, the burst mode 312 would communicate directly with the delivery system 308 to relatively immediately dispense the air treatment. A user may actuate a button or another indication may be provided, which would signal that immediate dispensing of an air treatment is desired. This may further provide an air treatment to mask, neutralize or otherwise remove malodors within the area. The burst mode may function alone or in combination with either or both of a timed treatment and a sensor activated treatment.

Another aspect in accordance with various embodiments of the invention is a “kill mode.” A kill mode turns off the air treatment device if a determination is made the device it is not positioned upright. In an exemplary embodiment, the air treatment device comprises an actuator configured to be pushed in by a surface, upon which the device is situated, when the device is upright, and not pushed in when the device is positioned other than upright. In another exemplary embodiment, the air treatment device comprises an acrylic level vial, in communication with a circuit or signal pathway within the air treatment device, configured to determine the orientation of the device and take appropriate action in response thereto. In yet another embodiment, the air treatment device is mechanically or electrically configured such that a circuit or signal is disrupted or stopped if the device is positioned other than upright. In general, any configuration for turning off the air treatment device if a determination is made the device it is not positioned upright is contemplated for use in the present invention.

In an exemplary embodiment, upon activation (or at any point during operation) the consumer sets the mode in which the air treatment system will operate via the selection mechanism. Next, the timing control circuit activates the air treatment device according to the selection mechanism. The selection mechanism controls the duration of the treatment, “on time” and the intervening time between treatments, “off time” thereby allowing the delivery system to dispense air treatment according to the desired level chosen by the consumer.

Additionally, during operation of a sensing treatment, the sensor and its control circuitry may also continuously sample the environment for either the level of active air treatment material or the environmental air quality. The level of active air treatment material is sampled by the sensor so as to maintain the desired level of environmental air quality. The environmental air quality is sampled by the sensor so that in response to a decrease in the desired environmental air quality, the quantity of air treatment material distributed may be increased. If the predetermined level of environmental air quality is not satisfactory, i.e. the sensor detects a malodor, the sensor communicates with the timing control circuit to provide an increase in air treatment. Specifically, the sensor detects a malodor and sends an indicator signal to the timing control circuit. The timing control circuit then actuates the delivery system accordingly. This action continues until the sensor determines the environmental air quality has returned to the desired level of environmental air quality or the timing control circuit has determined that a significant enough period of increased air treatment has occurred. The sensor determines the desired level of environmental air quality by monitoring the air quality and sending indicator signals to the timing control circuit until the desired level is reached.

During operation of a timed treatment, the duration and intervening time are set according to the selection mechanism and dispense air treatment accordingly. It should be understood that the air treatment system dispenses air treatment according to timed intervals or in response to detection of a malodor.

Further, if the timing control circuit determines a significant period of increased air treatment, the timing control circuit disengages the sensor for an operational time period via the feedback loop. After the time period, the sensor re-engages and once again begins sampling. Additionally, the sensor communicates with the timing control circuit through the feedback loop to determine when the air treatment delivery system has been actuated and, thus, allows the sensor sufficient time to be either off (if the consumer is sensitive to initiating the air treatment system) or to correct the baseline of the sensor response to account for the air treatment system.

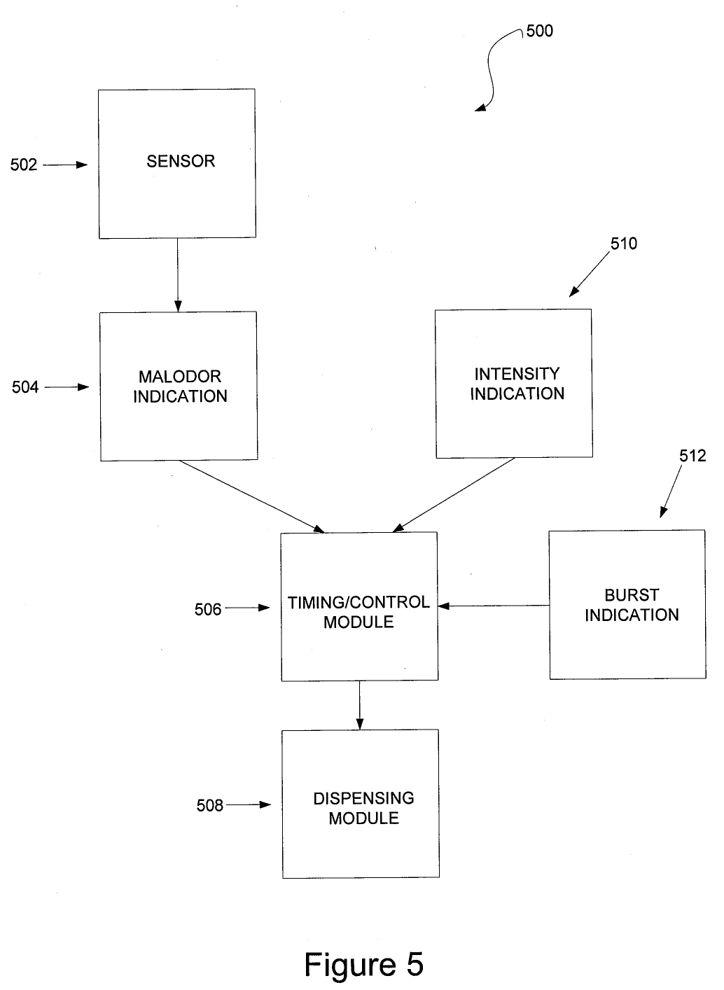

FIG. 5 is a flow diagram of a method and system 500 of active dispensing of an air treatment, according to an exemplary embodiment. In various exemplary embodiments, method and system 500 dispense an air treatment in many different manners, such as the three shown in FIG. 2. In accordance with one exemplary embodiment, system 500 dispenses an air treatment includes a sensor 502 sensing an activation malodor or low level of an air treatment and sending a malodor indication 504 to a timing/control module 506. Any suitable sensor, including those discussed above, exhibiting the qualities discussed herein may be used. The timing/control module 506 would then send a dispensing signal to a dispensing module 508 to indicate to the dispensing module 508 to dispense a volatizable liquid or fragrance. This is one mode of operation for system 500.

In accordance with another exemplary embodiment, system 500 includes the setting of an intensity indication 510. The intensity indication 510 may be set by a user, which would send an activation signal to the timing/control module 506 to periodically activate the dispensing module 508 and at a desired intensity. This may be a user preference, in that a volatizable liquid or fragrance would be dispensed at regular periodic intervals and at a desired intensity, both of which may be increased or decreased to certain limits, depending on the consumer's desired treatment intervals and intensity. In accordance with one aspect of an exemplary embodiment, this is a factory setting, pre-set before the system is activated.

In accordance with yet another exemplary embodiment, system 500 includes a burst indication 512. The burst indication 512 may be initiated by an actuator on the system to immediately dispense the air treatment. The burst indication 512 would communicate with the timing/control module 506, which would then activate the dispensing module 508 to relatively immediately dispense the air treatment. In a particular embodiment, a user actuates a button or another indication is provided, which signals that immediate dispensing of an air treatment is desired. This may further provide an air treatment to mask, neutralize or otherwise remove malodors within the area.

In addition to dispensing an air treatment and in accordance with various embodiments, dispensing module 508 also comprises an aerosol or other method of rapid deploying an air treatment within the area. For example, system 500 may include a multi-position switch to indicate to the system which mode to operate in. Importantly, each mode may function alone or in combination with one or more of a sensor mode, an intensity indication mode and a burst indication mode.

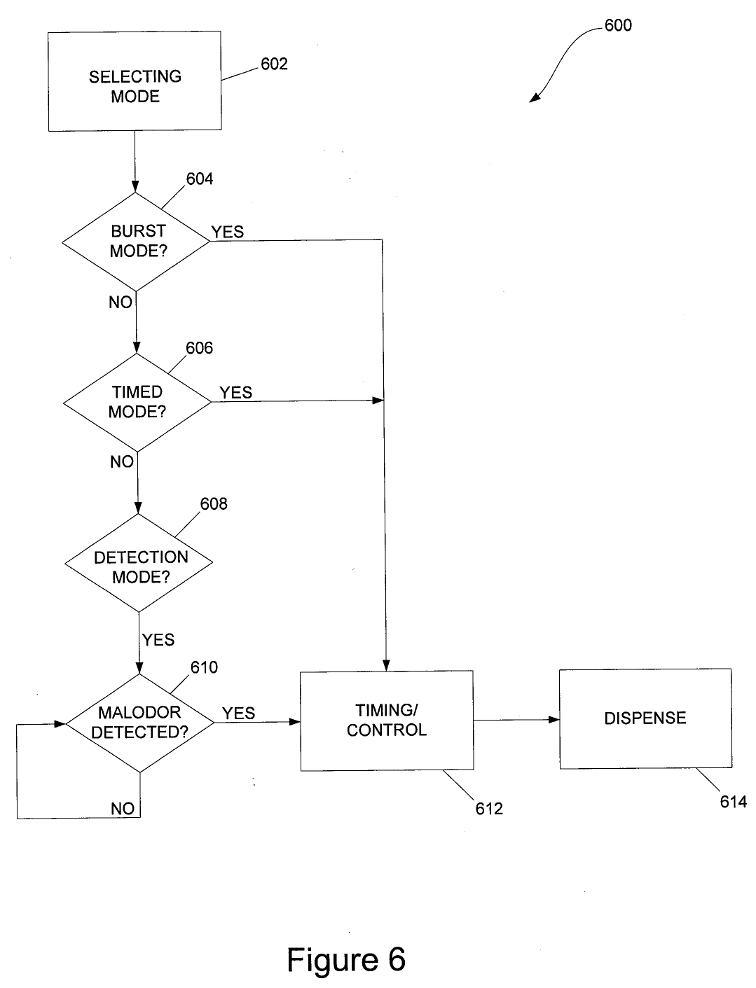

FIG. 6 shows a flow diagram of a method 600 of active dispensing, according to an exemplary embodiment. In this embodiment, method 600 includes selecting a mode 602, determining if it is a burst mode 604, determining if it is a timed mode 606, determining if it is a detection mode 608, malodor detection 610, performing timing and control 612, and dispensing 614.

Selecting a mode 602, in an embodiment, includes selecting a mode of operation of an air treatment device. This may be done manually by a user, or may be generally automatic. The device may comprise any number of modes, from one to hundreds or more. Each mode may function alone or in combination with another or others. In this embodiment there are three modes.

After selecting a mode 602, a determination is made of whether the system is in a burst mode 604. If the system is in a burst mode 604, the YES leg is taken to the timing and control step 612 followed by the dispensing step 614, which would, relatively immediately, dispense an air treatment in a burst or aerosol configuration. In an exemplary embodiment, in a burst mode 604, the consumer may activate the burst mode 604, relatively independent of a timed mode 606 or a detection mode 608. Selecting burst mode 604 may or may not reset the timed mode 606 or deactivate the detection mode 608 for a time period, depending on the air treatment and its method of delivery. If the burst mode determination is negative, the NO leg is taken to determine whether the system is in a timed mode 606.

If the system is in a timed mode 606, the YES leg is taken to the timing and control step 612 followed by the dispensing step 614. In an exemplary embodiment of a system in a timed mode 606, the timing and control step 612 periodically sends a signal to the dispensing step 614. This periodic signaling may be preset or may be customizable by the user in terms of duration as well as intensity. If the timed mode determination is negative, the NO leg is taken to determine whether the system is in a detection mode 608.

If the system is in a detection mode 608, the YES leg is taken to the malodor detection step 610. If a particular type of malodor or low level of an air treatment is detected 610, the YES leg is taken to the timing and control step 612 followed by the dispensing step 614. If the system is in a detection mode 608 and a malodor is not detected 610, the NO leg is taken and the malodor detection step 610 continues until a malodor is detected 610, upon which the YES leg is taken to the timing and control step 612 followed by the dispensing step 614.

In an alternative embodiment, an air-freshening system is shown that combines a continuous dispensing device with a sensing dispensing device. The continuous dispensing device is a plug-in scented oil warmer/dispenser while the sensing dispensing device is similar to the air treatment device described above. The scented oil warmer portion of the device will provide a continuous fragrance, while the sensing air treatment device will be automatically actuated, as described above, when the sensor detects a malodor, providing a large boost of fragrance or an odor neutralizer via an aerosol dispersed from the air treatment device to remove the malodor. Since the aerosol is automatically actuated and is controlled by the odor sensor, there is no active involvement by the user in this device.

As used herein, the terms “comprise”, “comprises”, “comprising”, “having”, “including”, “includes”, or any variation thereof, are intended to reference a non-exclusive inclusion, such that a process, method, article, composition or apparatus that comprises a list of elements does not include only those elements recited, but can also include other elements not expressly listed and equivalents inherently known or obvious to those of reasonable skill in the art. Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters or other operating requirements without departing from the scope of the instant invention and are intended to be included in this disclosure.

Moreover, unless specifically noted, it is the Applicant's intent that the words and phrases in the specification and the claims be given the commonly accepted generic meaning or an ordinary and accustomed meaning used by those of reasonable skill in the applicable arts. In the instance where these meanings differ, the words and phrases in the specification and the claims should be given the broadest possible, generic meaning. If it is intended to limit or narrow these meanings, specific, descriptive adjectives will be used. Absent the use of these specific adjectives, the words and phrases in the specification and the claims should be given the broadest possible meaning. If any other special meaning is intended for any word or phrase, the specification will clearly state and define the special meaning.

It should be understood that the foregoing description is of exemplary embodiments of the invention only, and that the invention is not limited to the specific forms shown. Various modifications may be made in the design and arrangement of the elements set forth herein without departing from the scope of the invention.

What is claimed is:

1. An air treatment device for dispensing an air treatment comprising:
a housing;
a first dispensing mechanism;
a second dispensing mechanism, wherein said second dispensing mechanism comprises:
a sensor;
a timing control circuit coupled with said sensor; and
a delivery system coupled with said timing control circuit; and
a reservoir in communication with said first dispensing mechanism.

2. A device as in claim 1, wherein said reservoir is further in communication with said second dispensing mechanism.

3. A device as in claim 1, further comprising a second reservoir in communication with said second dispensing mechanism.

4. A device as in claim 1, wherein said first dispensing mechanism is configured to dispense an air treatment in a first intensity or first predetermined interval, wherein said second dispensing mechanism is configured to dispense said air treatment in a second intensity or second predetermined interval, and wherein said second intensity is higher than said first intensity and said second predetermined interval is shorter than said first predetermined interval.

5. A device as in claim 1, wherein said second dispensing mechanism is configured for one or more of a timed treatment, a sensing treatment, and an on-demand treatment.

6. A device as in claim 1, wherein said sensor is configured to detect one or more malodors.

7. A device as in claim 1, wherein said sensor is configured to detect one or more of motion, heat, light, air treatment, intensity, and humidity.

8. A device as in claim 1, comprising a plurality of said sensors, each of said sensors being configured to detect one or more malodors.

9. An air treatment device for dispensing an air treatment comprising:
a housing;
a sensor comprising at least two prongs and a wire coupled between said prongs;
a timing control circuit coupled with said sensor; and
a delivery system coupled with said timing control circuit.

10. A device as in claim 9, wherein said prongs comprise a piezoelectric material.

11. A device as in claim 10, wherein said piezoelectric material comprises quartz crystal.

12. A device as in claim 9, wherein said wire comprises a porous material.

13. A device as in claim 12, wherein said porous material comprises a polymer.

14. A device as in claim 13, wherein said polymer is configured to adsorb at least one malodor.

15. A device as in claim 9, comprising a plurality of said sensors, each of said sensors being configured to detect one or more malodors.

16. A device as in claim 9, wherein said wire releases mechanical stress upon detection of a malodor.

17. A device as in claim 9, wherein a property of said wire changes upon detection of a malodor.

18. A device as in claim 17, wherein a property of said prongs changes upon said property of said wire changing.

19. An air treatment device for dispensing an air treatment when needed comprising:
a housing;
a sensor;
a timing control circuit coupled with said sensor;
a delivery system coupled with said timing control circuit; and
wherein said air treatment device is configured to detect the uprightness of said air treatment device and turn off said air treatment device if not upright.

20. A device as in claim 19 further comprising an actuator positioned on the underside of the housing, wherein said actuator is pressed in if said air treatment device is upright and not pressed in if said air treatment device is not upright.
